(19) United States
(12) Patent Application Publication
(10) Pub. No.: US 2013/0278940 A1
(43) Pub. Date: Oct. 24, 2013

(54) OPTICAL TOUCH CONTROL SYSTEM AND CAPTURED SIGNAL ADJUSTING METHOD THEREOF

(71) Applicant: WISTRON CORPORATION, New Taipei City (TW)

(72) Inventors: Yu-Yen CHEN, New Taipei City (TW); Lin-Husng CHANG, New Taipei City (TW); Po-Liang HUANG, New Taipei City (TW); Kai-Chung CHENG, New Taipei City (TW)

(73) Assignee: WISTRON CORPORATION, New Taipei City (TW)

(21) Appl. No.: 13/668,926

(22) Filed: Nov. 5, 2012

(30) Foreign Application Priority Data
Apr. 24, 2012 (TW) 101114555

(51) Int. Cl. G01B 11/14

(52) U.S. Cl. 356/614

(57) ABSTRACT

An optical touch control system and a captured signal adjusting method thereof are disclosed. The optical touch control system includes a base, an image sensor module, and an image processing device. The base has an edge frame. The image sensor module is disposed on the base and used for capturing the edge frame to obtain a testing image signal. The image processing device includes a processing module, a recognition module, and a record module. The processing module is used for executing a testing procedure. The recognition module is used for scanning the testing image signal. When the processing module executes the testing procedure, the recognition module recognizes a coordinate of an edge frame image from the testing image signal. Then the processing module is used for setting the coordinate of the edge frame image as a correct capture coordinate to record in the record module.

### BACKGROUND OF THE INVENTION

1. Field of the Invention

The present disclosure relates to an optical touch control system and a captured signal adjusting method thereof, and more particularly relates to an optical touch control system and a captured signal adjusting method thereof capable of adjusting capturing angles.

2. Description of the Related Art

As the advancement of technology, there is an optical touch control system. The structure and actuation mechanism of the optical touch control system are providing a light source by a light emitting module in a background field to a reflecting side frame to produce reflected light or disposing a light emitting side frame to provide light source directly. Therefore, when an object to be recognized is approaching, the light source is sheltered and a dark shadow is produced. An image sensor module is used for capturing the image with the dark shadow. The position of the dark shadow is calculated so that a coordinate of the object to be recognized is obtained. Therefore, the edge frame has the functions to obstruct external disturbance source and to distinguish the object to be recognized from the background so that the correct position of the object to be recognized may be identified more easily.

Next, please refer to FIG. 1A, which illustrates a side view diagram of an optical touch control system in the prior art. FIG. 1B illustrates a captured image obtained by an image sensor module according to FIG. 1A in the prior art.

In the example of FIG. 1A, the optical touch control system 90 includes a base 91, an image sensor module 92 and an edge frame 93. The image sensor module 92 is disposed on the base 91 for capturing images in the direction facing the edge frame 93. Therefore, the image sensor module 92 should be assembled horizontally for best case. The image sensor module 92 captures the edge frame 93 according to the first capturing angle θ 1. As illustrated in FIG. 1B, the image signal 94 captured by the image sensor module 92 should have a horizontal edge frame 941 that locates at the coordinate of the second row R2. But, in the prior art, the capturing angle of the image sensor module 92 may be incorrect. For example, the assembly of the image sensor module 92 and the base 91 may have certain inaccuracy and renders component bias of the image sensor module 92 or unevenness of the base 91. In such case, the capturing angle of the image sensor module 92 may be the second capturing angle θ 2 and directly capturing the surface of the base 91. On the other hand, the image sensor module 92 may also have the capturing angle of the third capturing angle θ 3, exceeding the boundary of the edge frame 93. As such, the position of the edge frame image 941 may be biased to the first row R1 or the third row R3. Meanwhile, the edge frame image 941 may have skewed shape.

Either the second capturing angle θ 2 or the third capturing angle θ 3 causes too much disturbance source in the captured image signal. If the optical touch control system 90 has to re-calculate to remove the disturbance source in the captured image signal each time after the captured image signal is captured each time by the image sensor module 92, it is consumes a lot of system resources of the optical touch control system 90.

Therefore, it is necessary to develop a new optical touch control system and a method for adjusting captured signal for curing the deficiencies of the conventional art.

### SUMMARY OF THE INVENTION

A major objective of the present disclosure is to provide an optical touch control system capable of adjusting capturing angles.

Another major objective of the present disclosure is to provide a captured signal adjusting method for the optical touch control system.

To achieve the aforementioned objectives, an optical touch control system of the present disclosure is under an ambient light source. The optical touch control system includes a base, an image sensor module and an image processing device. The base has an edge frame. The image sensor module is disposed on the base and the image sensor module is used for capturing the edge frame to obtain a testing image signal. The image processing device is electrically connected to the image sensor module. The image processing modules includes a processing module, a recognition module and a recording module. The processing module is used for executing a testing procedure. The recognition module is electrically connected to the processing module for scanning the testing image signal. The recording module is electrically connected to the processing module. When the processing module executes the testing procedure, the recognition module is used for recognizing a coordinate of an edge frame image from the testing image signal and setting the coordinate of the image of the edge frame as a correct capturing coordinate to be recorded in the recording module.

A method of the present disclosure is used for adjusting an image sensor module of an optical touch control system to adjusting a captured signal. The method includes the following steps: executing a testing procedure, comprising: providing a base in an ambient light source, wherein the base has an edge frame; obtaining a testing image signal by capturing the edge frame; scanning the testing image signal to recognize a coordinate of an edge frame image of the testing image signal; setting the coordinate of the edge frame image as a correct captured coordinate; and recording the corrected captured coordinate; and executing an adjusting procedure, comprising: capturing an captured image signal by performing capturing; reading the correct captured coordinate; and performing a selection in the captured image signal according to the correct captured coordinate directly to obtain an adjusted image signal.

### BRIEF DESCRIPTION OF THE DRAWINGS

FIG. 1A is a side view diagram of an optical touch control system in the prior art;

FIG. 1B illustrates a captured image of the image sensor module according to FIG. 1A in the prior art;

FIG. 2 is an optical touch control system according of the present disclosure;

FIG. 3A is a side view diagram of the optical control system according of the present disclosure;

FIG. 3B illustrates a captured image signal of the image sensor module according of the present disclosure according to FIG. 3A; and

FIG. 4A to FIG. 4B illustrate a procedure chart of a method for adjusting captured signal according of the present disclosure.

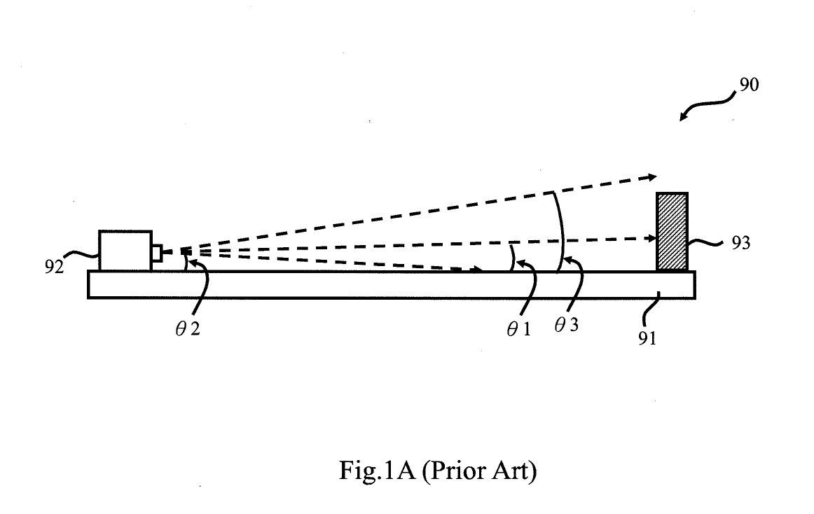

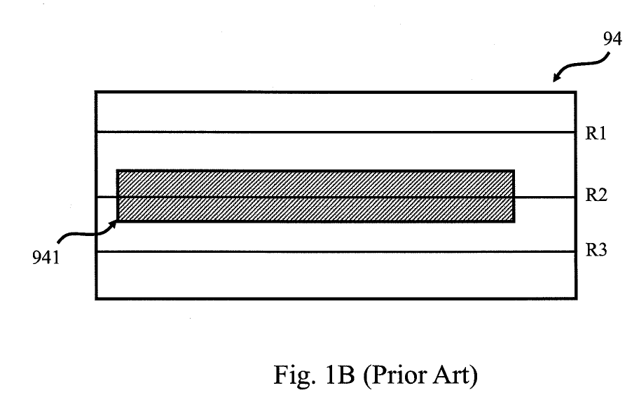

### DETAILED DESCRIPTION OF THE PREFERRED EMBODIMENTS

The advantages and innovative features of the disclosure will become more apparent from the following detailed description when taken in conjunction with the accompanying drawings.

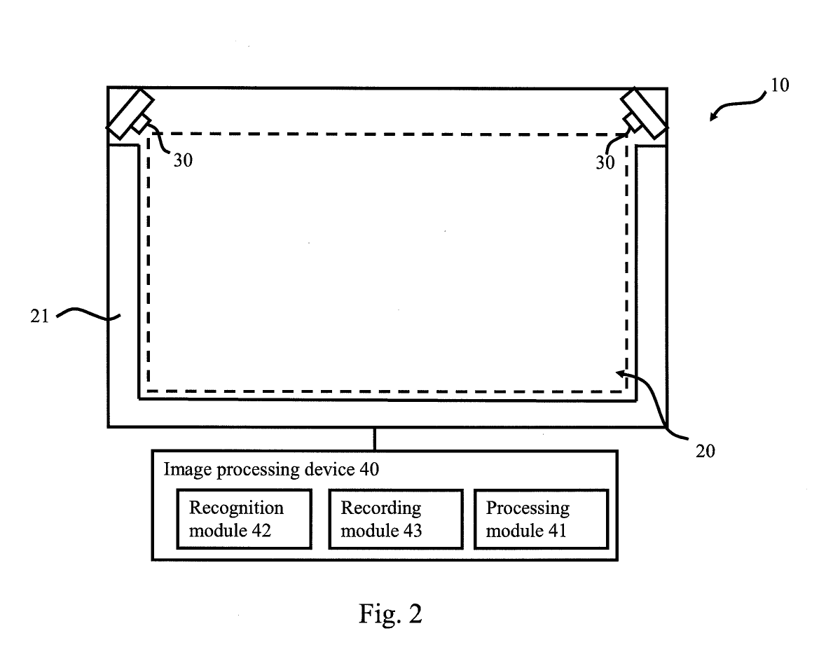

Please refer to FIG. 2, which is a schematic diagram of an optical touch control system according of the present disclosure.

The optical touch control system 10 of the present disclosure includes a base 20, an image sensor module 30 and an image processing device 40. The base 20 has an edge frame 21. In one embodiment of the present disclosure, the base 20 is a rectangle shape with four lateral sides, and its surface is disposed with a glass or acrylic surface. The edge frame 21 is disposed on the lateral sides of a left side, a bottom side and a right side of the base 20. The image sensor module 30 may be a CCD or other modules with image capturing function. In one embodiment of the present disclosure, the optical touch control system 10 has two image sensor modules 30 separately disposed on the corresponding corners of the lateral side of an upper side of the base 20. In addition, the image sensor module 30 has different capturing angles so that it is able to capture a larger scope captured image signal. Please be noted, however, that the present disclosure is not limited to only mentioned structure. For example, the shape, structure and position of the edge frame 21, or the amount and position of the image sensor modules 30 are not limited to that exemplified in FIG. 2.

The image processing device 40 is electrically connected to the image sensor module 30 for receiving the captured image signal to perform further processing. The image processing device 40 may be disposed on a circuit board fixed to the base 20 or be connected externally to the image sensor module 30 by extended form, but the present disclosure is not limited to such configuration, either. The image processing device 40 includes a processing module 41, a recognition module 42 and a recording module 43. The processing module 41 may be implemented by hardware, hardware combined with software, or hardware combined with firmware. The image processing device 40 may execute a testing procedure and an adjusting procedure by using the recognition module 42 and the recording module 43 to adjust the captured image signal obtained by the image sensor module 30. The recognition module 42 may be implemented by hardware, hardware combined with software, or hardware combined with firmware to scan the signal captured by the image sensor 30. The recording module 43 may be a hardware structure with storage function for recording the recognition result of the recognition module 42.

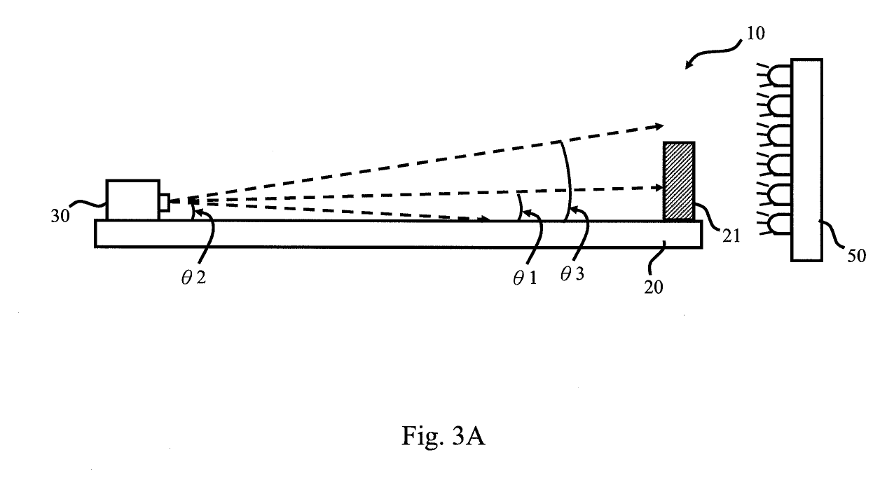

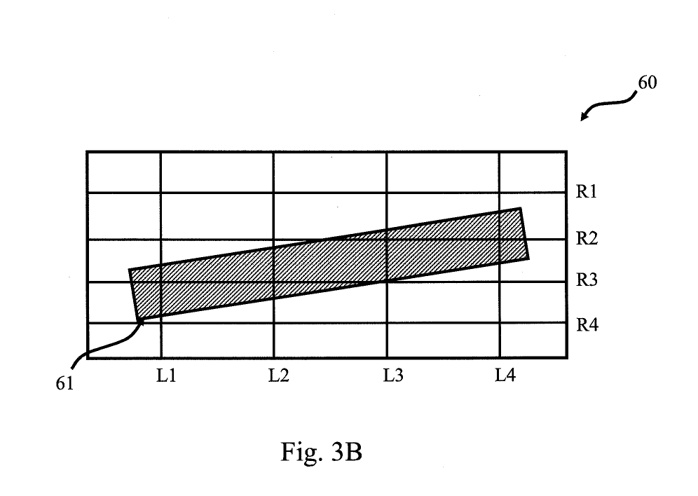

Next, please refer to FIG. 3A, which illustrates a side view of the optical touch control system according of the present disclosure.

The base 20 of the optical touch control system 10 is disposed under an ambient light source. In a preferred embodiment of the present disclosure, the ambient light source is provided by a light emitting device 50. The light emitting device 50 may be a whole surface light emitting wall for providing stable light source. As such, when the image sensor module 30 is capturing images, the surface of the base 20 and area exceeding the edge frame 21 are displayed as light points and the back light image of the edge frame 21 as dark points so as to distinguish the position of the edge frame 21.

As illustrated in FIG. 3B, FIG. 3B illustrates the testing image signal captured by the image sensor modules of the present disclosure according to FIG. 3A.

The testing image signal 60 obtained by the image sensor module 30 has a clear edge frame image 61. Therefore, when the processing module 30 executes the testing procedure, the image sensor module 30 captures images of the edge frame 21 in all capturing angles, e.g. the first capturing angle θ 1 to the third capturing angle θ 3, to obtain the testing image signal 60. Please be noted, however, that the present disclosure is not limited to capturing only three capturing angles for the image sensor module 30.

Next, the processing module 41 controls the recognition module 42 to scan the testing image signal to identify the coordinate of the edge frame image 61 in the testing image signal. In the embodiment of the present disclosure, the light source provided from the light emitting device 50 makes the edge frame 21 in the back light position. Therefore, the recognition module 42 may regard the coordinates of the plurality of dark points in the testing image signal 60 as the edge frame image 61 representing the edge frame 21. In the example of FIG. 3B, the recognition module 52 identifies the third row R3 of the first line L1, the third row R3 of the second line L2, the second row R2 of the third line L3, and the fourth line L4 of the second row R2 as the coordinates of the dark points. The recognition module 42 may scan dark points in each unit pixel of the testing image signal to accurately identify the coordinates of the image of the edge frame images 61.

In addition, each row of FIG. 3B may represent one capturing angle of the image sensor module 30. The first row R1 represents the third capturing angle θ 3, the second row R2 represents the first capturing angle θ 1, and the fourth row R4 represents the second capturing angle θ 2. In addition, the third row R3 represents the fourth capturing angle (now shown in FIG. 3A). Next, the processing module 41 sets the coordinates of the aforementioned edge frame image 61 as correct capturing coordinates and stores them in the recording module 43. As such, when the image sensor module 30 performs capturing again, the processing module 41 executes the adjusting procedure for reading the correct capturing coordinates to adjust the captured image signal of the image sensor module 30. That is, the capturing angles of each pixel of the image sensor module 30 are adjusted and only correct capturing angles are remained.

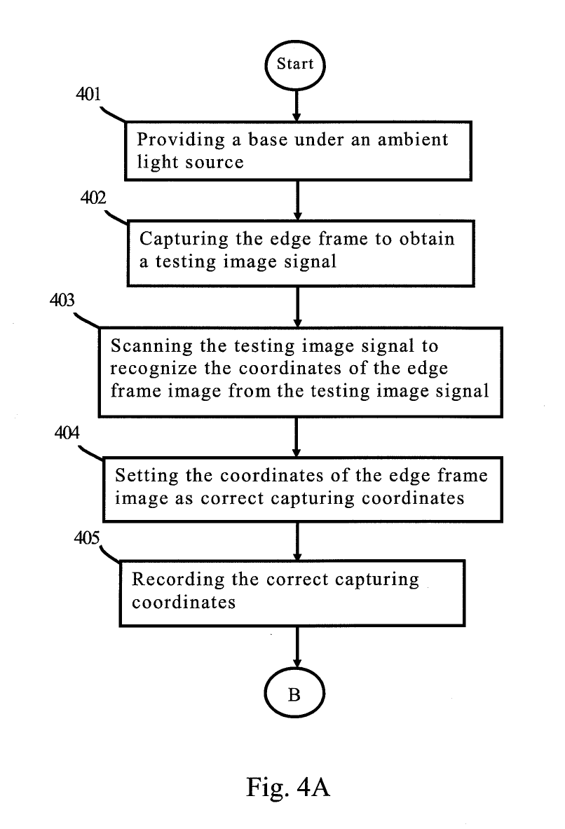

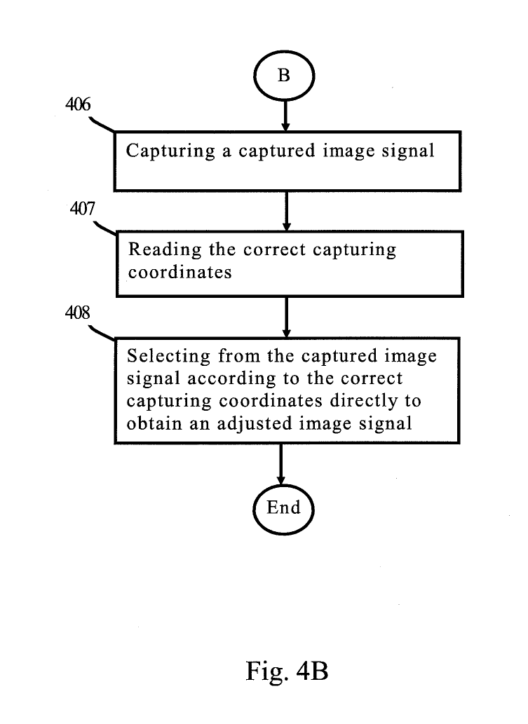

Next, please refer to FIG. 4A-4B, which illustrate the method for adjusting the captured signal of the present disclosure. Please be noted, however, that although the optical touch control system 10 is used below for explaining the method for adjusting the captured signal of the present disclosure, the method for adjusting the captured signal is not limited to only the same structure of the optical touch control system 10. The steps from step 401 to the step 405 of FIG. 4A are the testing procedure of the present disclosure, and the steps from step 406 to the step 408 of FIG. 4B are the adjusting procedure of the present disclosure.

When the optical touch control system 10 of the present disclosure performs the testing procedure, the method goes to the step 401: providing a base under an ambient light source.

Firstly, the base 20 is disposed under the ambient light source. In the preferred embodiment of the present disclosure, the base 20 is disposed before the light emitting device 50 to obtain a stable light source signal.

Next, the method goes to the step 402: capturing the edge frame to obtain a testing image signal.

Next, the image sensor module 30 capturing the edge frame 21 to obtain a testing image signal 60 with the direction facing the edge frame 21.

Next, the method goes to the step 403: scanning the testing image signal to recognize the coordinates of the edge frame image from the testing image signal.

Next, the processing module 41 controls the recognition module 42 to scan the testing image signal for recognizing each pixel of the testing image signal 60 and identifying positions of the dark points of each pixel in the testing image signal in order to determine the coordinates of the edge frame image 61. As illustrated in FIG. 3B, the recognition module 42 identifies the third row R3 of the first line L1, the third row R3 of the second line L2, the second row R2 of the third line L3 and the second row R2 of the fourth line L4 as the coordinates of the dark points.

Next, the step 404 is performed: setting the coordinates of the edge frame image as correct capturing coordinates.

After identified the coordinates of dark points in each pixel in the step 403, the processing module 41 regards the coordinates of the dark points as the position of the edge frame image 61 in the testing image signal 60 and the correct capturing angles of the image sensor module 30. Therefore, the processing module 41 sets the coordinates of the edge frame image 61 as the correct capturing coordinates.

Finally, the method goes to the step 405: recording the correct capturing coordinates.

At last, the processing module 41 records the correct capturing coordinates in the recording module 43 to be used in latter adjusting procedure.

When the optical touch control system 10 executes the adjusting procedure, the method goes to the step 406 at first: capturing a captured image signal.

Firstly, the image sensor module 30 captures images at the same direction facing the edge frame 21 to capture the captured image signal.

Next, the step 407 is performed: reading the correct capturing coordinates.

Next, when the image sensor module 30 captures images, the processing module 41 read correct capturing coordinates from the recording module 43. As illustrated in FIG. 3B, the third row R3 of the first line L1, the third row R3 of the second line L2, the second row R2 of the third line L3 and the second row R2 of the fourth line L4 are the coordinates of the dark points and the processing module 41 reads the aforementioned coordinates.

Finally, the method goes to the step 408: selecting from the captured image signal according to the correct capturing coordinates directly to obtain an adjusted image signal.

At last, the processing module 41 selects the adjusted image signal from the captured image signal directly according to the correct capturing coordinates. That is, when the image sensor module 30 performs image capturing, the processing module 41 sets the capturing angle of each pixel of the image sensor module 30, e.g. the capturing angle of the second row R2 or the third row R3 as illustrated in FIG. 3B. Therefore, the processing module 41 may adjust capturing angles by directly controlling the image sensor module 30 to obtain a correct adjusted image signal from the captured image signal so as to prevent obtaining too much unnecessary or error images.

Please be noted that the method for captured signals of the present disclosure is not limited to the aforementioned step order. The order of the steps may be changed if they can achieve the objectives of the present disclosure.

The testing procedure is only necessary to be executed for one time. That is, the procedure from the step 401 to the step 405 only needs to be executed for once and in later process, the image sensor module 30 only needs to execute the adjusting procedure when capturing images. As such, the processing speed of the optical touch control system 10 may be increased and correct image signal may be obtained.

It is noted that the above-mentioned embodiments are only for illustration. It is intended that the present disclosure cover modifications and variations of this disclosure provided they fall within the scope of the following claims and their equivalents. Therefore, it will be apparent to those skilled in the art that various modifications and variations can be made to the structure of the present disclosure without departing from the scope or spirit of the disclosure.

What is claimed is:

1. An optical touch control system used under an ambient light source, comprising:
a base having an edge frame;
an image sensor module disposed on the base for capturing the edge frame to obtain a testing image signal; and
an image processing device electrically connected to the image sensor module, the image processing device comprising:
a processing module for executing a testing procedure;
a recognition module electrically connected to the processing module for scanning the testing image signal;
a recording module electrically connected to the processing module; wherein when the processing module executes the testing procedure, the recognition module recognizes a coordinate of an edge frame image from the testing image signal, sets the coordinate of the edge frame image as a correct captured coordinate, and records the correct captured coordinate in the recording module.

2. The optical touch control system as claimed in claim 1, wherein when the image sensor module captures a captured image signal, the processing module further executes an adjustment procedure for selection in the captured image signal according to the correct captured coordinate directly to obtain an adjusted image signal.

3. The optical touch control system as claimed in claim 2, wherein the processing module adjusts a capturing angle of each unit pixel of the image sensor module to obtain the adjusted image signal.

4. The optical touch control module as claimed in claim 1, wherein the recognition module recognizes a plurality of dark points in the testing image signal as the coordinate of the edge frame image.

5. The optical touch control module as claimed in claim 4, wherein the recognition module recognizes the dark point in each unit pixel of the testing image signal as the coordinate of the edge frame image.

6. The optical touch control system as claimed in claim 1, wherein the base is neighboring to a light emitting device for obtaining the ambient light source by the light emitting device.

7. The optical touch control system as claimed in claim 1, wherein the optical touch control system comprises two image sensor modules separately disposed on two corresponding edge corners of a lateral side of the base.

8. The optical touch control system as claimed in claim 7, wherein the base is a rectangle shape with four lateral sides, the two image sensor modules located in two edge corners of an upper side, the edge frame disposed on lateral sides of a left side, a bottom side and a right side of the base.

9. A captured signal adjusting method used for adjusting an image sensor module of an optical touch control system, comprising:
executing a testing procedure, comprising:
providing a base in an ambient light source, wherein the base has an edge frame;
obtaining a testing image signal by capturing the edge frame;
scanning the testing image signal to recognize a coordinate of an edge frame image of the testing image signal;
setting the coordinate of the edge frame image as a correct captured coordinate; and
recording the corrected captured coordinate.

10. The captured signal adjusting method as claimed in claim 9, wherein the step of recognizing the coordinate of the edge frame in the testing image signal further comprises:
recognizing a plurality of dark points in the testing image signal as the edge frame coordinate.

11. The captured signal adjusting method as claimed in claim 10, wherein the step of recognizing the coordinate of the edge frame image further comprises:
recognizing the dark point in each unit pixel in the testing image signal as the coordinate of the edge frame image.

12. The captured signal adjusting method as claimed in claim 9, wherein the method further comprises:
executing an adjusting procedure, comprising:
capturing an captured image signal by performing capturing;
reading the correct captured coordinate; and
performing a selection in the captured image signal according to the correct captured coordinate directly to obtain an adjusted image signal.

13. The captured signal adjusting method as claimed in claim 12, wherein the step of executing the adjusting procedure further comprises:
adjusting a capturing angle of each unit pixel of the image sensor module to obtain the adjusted image signal.

14. The captured signal adjusting method as claimed in claim 13, wherein the step of executing the testing procedure further comprises:
providing a light emitting device to obtain the ambient light source.
